(19) United States
(12) Patent Application Publication
(10) Pub. No.: US 2019/0148973 A1
(43) Pub. Date: May 16, 2019

(54) COMPLEX CIRCUIT FOR CHARGING AND LOW-VOLTAGE COVERSION FOR ELECTRIC VEHICLE

(71) Applicant: EJINS CO., LTD., Anyang-si (KR)

(72) Inventor: Jin Il KIM, Seoul (KR)

(73) Assignee: EJINS CO., LTD., Anyang-si (KR)

(21) Appl. No.: 15/818,187

(22) Filed: Nov. 20, 2017

(30) Foreign Application Priority Data
Nov. 13, 2017 (KR) 10-2017-0150590

(51) Int. Cl. H02J 7/06; H02M 1/34; H02M 1/44; H02M 1/42; B60L 11/18; H02J 7/00

(52) U.S. Cl. CPC H02J 7/06; H02M 1/34; H02M 1/44; H02M 3/33592; B60L 11/1868; H02J 7/0068; H02M 1/4233

(57) ABSTRACT

Disclosed herein is a complex circuit for charging and low-voltage conversion for an electric vehicle. The complex circuit is provided with a power factor correction converter including a first inductor, a transformer, a first switching unit connected to primary-side terminals of the transformer, a second switching unit connected to secondary-side terminals of the transformer, and a first capacitor, in which the complex circuit is operated in a charging mode for generating a high voltage power source and a low-voltage conversion mode for generating a low voltage power source in accordance with operations of the first switching unit and the second switching in the power factor correction converter.

### CROSS REFERENCE TO RELATED APPLICATION

The present application claims priority to Korean Patent Application No. 10-2017-0150590, filed Nov. 13, 2017, the entire contents of which is incorporated herein for all purposes by this reference.

### BACKGROUND OF THE INVENTION

### 1. Field of the Invention

The present invention relates to a complex circuit for charging and low-voltage conversion for an electric vehicle. More particularly, the present invention relates to a complex circuit for charging and low-voltage conversion for an electric vehicle in which an on-board charger (OBC) circuit and a low voltage DC/DC converter (LDC) circuit for the electric vehicle are configured such that a portion of the OBC circuit is shared in the LDC circuit.

### 2. Description of the Related Art

In recent years, in response to exhaustion of fossil fuels and development trends of environmentally friendly vehicles, technologies related to electric vehicles using electric energy instead of fossil fuels are rapidly developing.

Because electric vehicles use electricity as a power source, the electricity must be stored. To this end, the electric vehicle is provided with a battery charged by a commercial high voltage power source. The electric vehicle is provided with the OBC circuit for charging the battery.

The OBC circuit is a slow charging circuit that converts a commercial power source of an alternating current applied from the outside into a direct current and charges the battery with the converted voltage. The voltage charged in the battery by the OBC circuit is a high-voltage direct current supplied to a motor for driving the electric vehicle.

In addition, the electric vehicle requires a low-voltage direct current to operate electrical components inside. Therefore, the electric vehicle is provided with the LDC circuit for converting a high voltage direct current output from the OBC circuit into a low voltage direct current. The LDC circuit receives the output of the OBC circuit as an input, converts it to a low voltage 12V direct current, and supplies the converted voltage to the electrical components of the electric vehicle.

FIGS. 1A and 1B are diagrams showing an OBC circuit and an LDC circuit provided in a conventional electric vehicle. As shown in the figures, in the conventional electric vehicle, the OBC circuit in FIG. 1A and the LDC circuit in FIG. 1B are provided separately.

As shown in FIG. 1A, the conventional OBC circuit includes an EMI filter 11, a rectifier circuit 12, a boost converter 13, a buck converter 14, and a resonant converter 15. The OBC circuit converts an externally applied alternating current power source into a high-voltage direct current with which a high voltage battery HVB is charged.

Also, as shown in FIG. 1B, the conventional LDC circuit includes an EMI filter 21 and a full-bridge converter 22. The LDC circuit converts the high-voltage direct current supplied from a high voltage battery HVB into a low-voltage direct current with which a low voltage battery LVB is charged.

Thus, in the conventional electric vehicle, since the OBC circuit and the LDC circuit are separately configured, these circuits include respective transformers. Therefore, a weight of each of the OBC circuit and the LDC circuit in the electric vehicle is increased, and a manufacturing cost of each circuit is also increased.

### SUMMARY OF THE INVENTION

Accordingly, the present invention has been made keeping in mind the above problems occurring in the prior art, and an object of the present invention is to provide a complex circuit for charging and low-voltage conversion for an electric vehicle in which an on-board charger (OBC) circuit and a low voltage DC/DC converter (LDC) circuit for the electric vehicle are configured such that a portion of the OBC circuit is shared in the LDC circuit.

In order to accomplish the above object, the present invention provides a complex circuit for charging and low-voltage conversion for an electric vehicle, the complex circuit including a rectifier for rectifying an alternating current power source applied from an outside; a power factor correction converter including a first inductor, a transformer, a first switching unit connected to primary-side terminals of the transformer, a second switching unit connected to secondary-side terminals of the transformer, and a first capacitor, the power factor correction converter having an insulating-type structure by the transformer; a surge snubber configured to eliminate a surge current due to an inductance collision of the first inductor and the transformer; a tertiary-side rectifier connected to tertiary-side terminals of the transformer; and an LC filter for smoothing an output of the tertiary-side rectifier.

In a charging mode of the electric vehicle, the power factor correction converter allows a high-voltage power source generated from the alternating current power source to be provided to a high voltage battery. Also, in a low-voltage conversion mode of the electric vehicle, the power factor correction converter allows the high voltage power source provided from the high voltage battery to be provided to the tertiary-side rectifier and the high voltage power source to be converted into a low voltage power source by the tertiary-side rectifier to be provided to a low voltage battery.

The complex circuit for charging and low voltage conversion for the electric vehicle according to the present invention includes the OBC circuit for charging a high voltage battery and the LDC circuit for charging a low voltage battery for an electric vehicle, in which a portion of the converter of the OBC circuit is shared in the LDC circuit, whereby it is possible to reduce the number of elements constituting the complex circuit and a size of the entire circuit, thereby reducing manufacturing cost.

Further, the complex circuit for charging and low-voltage conversion of the present invention may improve an operation reliability of the OBC circuit by removing the surge current generated due to an inductance collision or converting the surge current into a voltage to provide the voltage to an output terminal of the OBC circuit.

Further, in the complex circuit for charging and low-voltage conversion of the present invention, since a voltage conversion circuit is not required to be provided at the output terminal of the LDC circuit, it is possible to reduce loss while generating the low-voltage direct current power source.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a diagram showing an OBC circuit of a conventional electric vehicle;

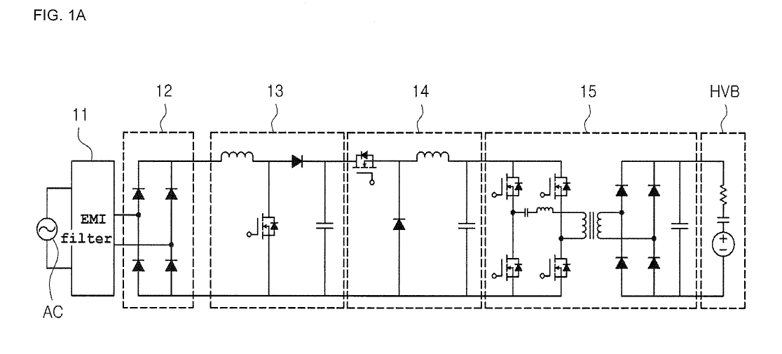

FIG. 1B is a diagram showing an LDC circuit of a conventional electric vehicle;

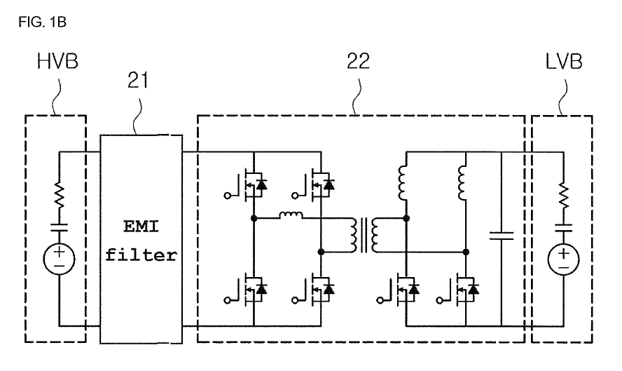

FIG. 2 is a diagram illustrating the configuration of a complex circuit for charging and low-voltage conversion for an electric vehicle according to an embodiment of the present invention;

FIG. 3 is a circuit diagram according to one embodiment of FIG. 2;

FIG. 4 is a circuit diagram according to another embodiment of FIG. 2;

FIG. 5 is a diagram showing an operation of a surge snubber of FIG. 2;

FIGS. 6A and 6B are diagrams showing circuits according to embodiments of a tertiary-side rectifier of FIG. 2;

FIG. 7 is a diagram illustrating a configuration of a complex circuit for charging and low-voltage conversion for an electric vehicle according to another embodiment of the present invention; and

FIG. 8 is a circuit diagram of FIG. 7.

### DESCRIPTION OF THE PREFERRED EMBODIMENTS

Hereinafter, embodiments of the present invention will be described with reference to the accompanying drawings.

It is to be noted that, among the drawings, the same components are denoted by the same reference numerals and symbols as possible even if they are shown in different drawings. In the following description of the present invention, detailed description of known functions and configurations incorporated herein will be omitted when it may make the subject matter of the present invention rather unclear. Also, when a part is referred to as “including” an element, it does not exclude other elements unless specifically stated to the contrary.

Also, terms and words used in the present specification and claims should not be construed in a conventional and dictionary sense, but should be construed in accordance with meanings and concepts consistent with the technical idea of the present invention based on the principle that inventors can properly to the concept of a term to describe its invention in the best way possible. Therefore, the embodiments described in the present specification and the configurations shown in the drawings are merely preferred embodiments of the present invention and are not intended to represent all of the technical ideas of the present invention, whereby various equivalents and modifications can be made at the time of filing of the present application and the scope of the present invention is not limited to the following embodiments.

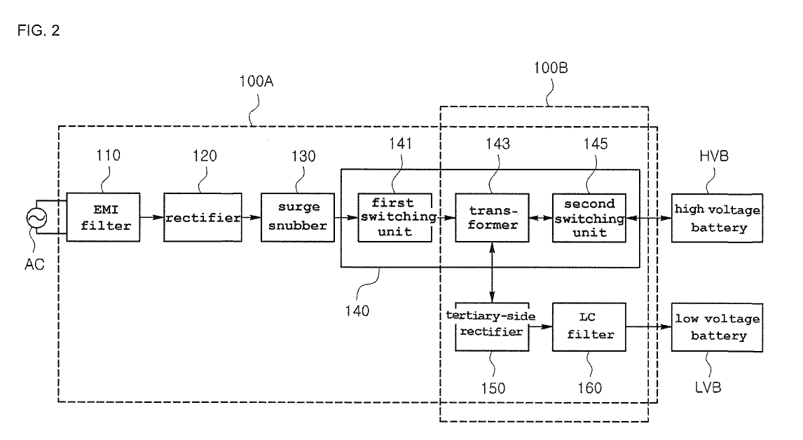

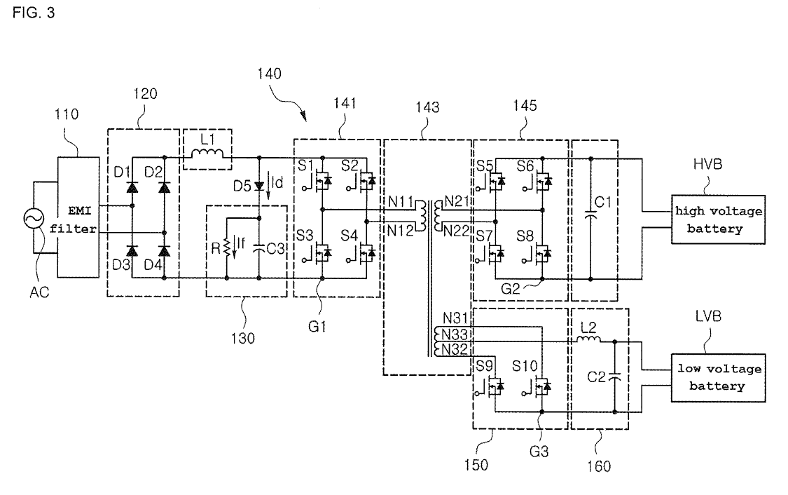

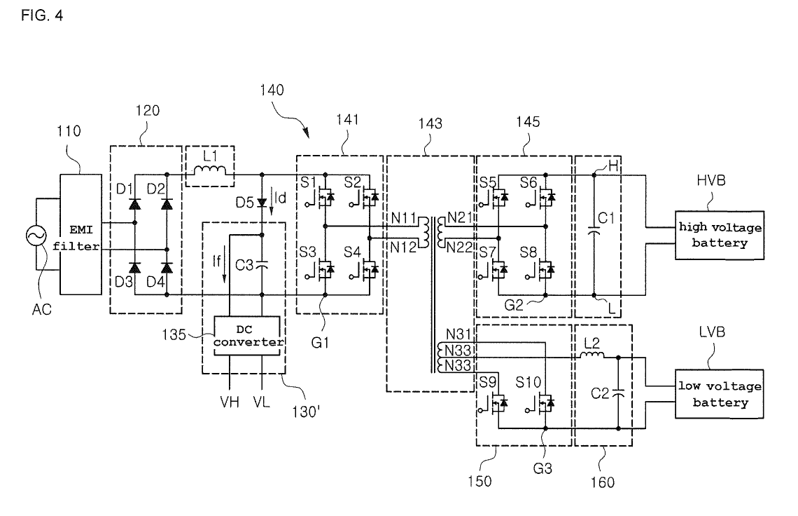

FIG. 2 is a diagram illustrating the configuration of a complex circuit for charging and low-voltage conversion for an electric vehicle according to an embodiment of the present invention, and FIGS. 3 and 4 are circuit diagrams according to an embodiment of FIG. 2.

As shown in the figures, a complex circuit for charging and low-voltage conversion for an electric vehicle according to the present embodiment may include an OBC circuit 100A and an LDC circuit 100B. As described above, the OBC circuit 100A is a circuit for charging a high voltage battery (HVB) of an electric vehicle, and the LDC circuit 100B is a circuit for charging a low voltage battery LVB of the electric vehicle.

The OBC circuit 100A may include an EMI filter 110, a rectifier 120, a surge snubber 130, and a power factor correction converter 140.

The EMI filter 110 may remove noise from an alternating current power source AC applied from the outside, or prevent a noise generated from a rear end of the EMI filter 110 from being applied to the alternating current power source AC.

The rectifier 120 can rectify the alternating current power source AC from which the noise is removed, that is output from the EMI filter 110. As shown in FIGS. 3 and 4, the rectifier 120 may include a plurality of diodes D1 to D4 as a full bridge circuit, but it is not limited thereto.

The power factor correction converter 140 may control such that a current and a voltage of the alternating current power source AC rectified through the rectifier 120 have the same phase, thereby improving the power factor of the alternating current power source AC. In addition, the power factor correction converter 140 performs power conversion on the phase-controlled alternating current power source AC to generate a high-voltage direct current power source, and supplies the power source to the high voltage battery HVB to be charged. In addition, the power factor correction converter 140 may provide the high-voltage DC power source provided from the high voltage battery HVB to a tertiary-side rectifier 150 of the LDC circuit 100B described below. That is, the power factor correction converter 140 of the present embodiment may be shared in the OBC circuit 100A and the LDC circuit 100B.

The power factor correction converter 140 may include a first inductor L1, a first switching unit 141, a transformer 143, a second switching unit 145, and a first capacitor C1.

The first inductor L1 may be connected in series between the rectifier 120 and the first switching unit 141. The first capacitor Cl can be connected in parallel between the second switching unit 145 and the high voltage battery HVB. A connection structure of the first inductor L1 and the first capacitor C1 is not limited to that shown in FIG. 3 and FIG. 4, but may have various connection structures for power factor improvement and power conversion of the power factor correction converter 140.

The first switching unit 141 may be connected between the first inductor L1 and primary-side terminals N11 and N12 of the transformer 143. The first switching unit 141 may include a plurality of switching elements, for example, the first switching element S1 to the fourth switching element S4 in the form of a full bridge circuit.

The first switching element S1 and the third switching element S3 may be connected in common to one primary-side terminal N11 of the transformer 143. The second switching element S2 and the fourth switching element S4 may be connected in common to the other primary-side terminal N12 of the transformer 143. Also, the first switching element S1 and the third switching element S3 may be connected in parallel with the second switching element S2 and the fourth switching element S4.

The first switching unit 141 can provide the current applied through the first inductor L1 to the primary-side terminals N11 and N12 of the transformer 143 in accordance with switching operations of the first switching element S1 to the fourth switching element S4. The first switching element S1 to the fourth switching element S4 may be configured with a field effect transistor (FET), a diode, or the like.

The transformer 143 may be a high frequency transformer that is configured with the primary-side terminals N11 and N12, secondary-side terminals N21 and N22 and tertiary-side terminals N31 and N32. Here, the tertiary-side terminals N31 and N32 of the transformer 143 may include an intermediate terminal N33. The transformer 143 can transmit the alternating current power source applied to the primary-side terminals N11 and N12 via the first switching unit 141 to the secondary-side terminals N21 and N22 and the tertiary-side terminals N31 and N32.

The transformer 143 may allow the primary-side terminals N11 and N12, the secondary-side terminals N21 and N22, and the tertiary-side terminals N31 and N32 to have an insulated structure. Accordingly, the power factor correction converter 140 can be operated as an insulating-type structure by the transformer 143

In other words, since each terminal of the transformer 143 of the power factor correction converter 140 is insulated, a first ground G1 of the first switching unit 141 connected to the primary-side terminals N11 and N12 of the transformer 143, a second ground G2 of the second switching unit 145 connected to the secondary-side terminals N21 and N22 of the transformer 143, and a third ground G3 of the tertiary-side rectifier 150 connected to the tertiary-side terminals N31 and N32 of the transformer 143 are different and are not connected to one another. Accordingly, the power factor correction converter 140 of the present embodiment may have an insulating-type structure in which the first switching unit 141 and the second switching unit 145 are insulated from each other, and the second switching unit 145 and the tertiary-side rectifier 150 are insulated from each other.

The second switching unit 145 may be connected between the secondary-side terminals N21 and N22 of the transformer 143 and the first capacitor C1. The second switching unit 145 may include a plurality of switching elements, for example, a fifth switching element S5 to an eighth switching element S8 in the form of a full bridge circuit.

The fifth switching element S5 and the seventh switching element S7 may be connected in common to one secondary-side terminal N21 of the transformer 143. The sixth switching element S6 and the eighth switching element S8 may be connected in common to the other secondary-side terminal N22 of the transformer 143. Also, the fifth switching element S5 and the seventh switching element S7 may be connected in parallel with the sixth switching element S6 and the eighth switching element S8.

The second switching unit 145 may provide a current or a voltage applied through the secondary-side terminals N21 and N22 of the transformer 143 to the first capacitor Cl in accordance with switching operations of the fifth switch element S5 to the eighth switching element S8. Here, the current or the voltage output through the second switching unit 145 may is be a high-level direct current. The fifth switching element S5 to the eighth switching element S8 may be constituted by a field effect transistor (FET), a diode, or the like.

Also, the second switching unit 145 may provide a high-level current or voltage applied from the high voltage battery HVB to the secondary-side terminal N21 of the transformer 143 in accordance with switching operations of the fifth switching element S5 to eighth switching element S8. This is because the transformer 143 and the second switching unit 145 constituting the power factor correction converter 140 of the OBC circuit 100A are shared in the LDC circuit 1008.

That is, the power factor correction converter 140 can control switching operations of the first switching unit 141 and the second switching unit 145. The power factor correction converter 140 may constitute a charging path to cause the alternating current power source AC applied from the outside to be converted to a high-voltage direct current power source and then applied to the high voltage battery HVB in a charging mode of the electric vehicle. Also, the power factor correction converter 140 may constitute a voltage conversion path to cause a high-voltage direct current power source applied from the high voltage battery HVB to be applied to the tertiary-side rectifier 150 of the LDC circuit 100B in a low-voltage conversion mode of the electric vehicle. In the charging path, both the first switching unit 141 and the second switching unit 145 of the power factor correction converter 140 can perform the switching operation. However, in the voltage conversion path, only the second switching unit 145 of the power factor correction converter 140 can perform the switching operation.

The surge snubber 130 may be connected in parallel between the first inductor L1 of the power factor correction converter 140 and the first switching unit 141. The surge snubber 130 can eliminate a surge caused due to a collision of an inductance of the first inductor L1 with a leakage inductance of the transformer 143. The surge snubber 130 prevents the first switching element S1 to the fourth switching element S4 of the first switching unit 141 from being damaged by the surge, thereby improving operational reliability of the OBC circuit 100A.

As shown in FIG. 3, the surge snubber 130 may include an switching element, that is, a fifth diode D5 having one end connected in parallel between the first inductor L1 and the first switching element 141, a third capacitor C3 connected in series between the other end of the fifth diode D5 and a ground, and a resistor R connected in parallel with the third capacitor C3 between the other end of the fifth diode D5 and the ground.

The surge snubber 130 shown in FIG. 3 removes the surge by allowing an eliminated current If corresponding to a portion of a surge current Id applied through the fifth diode D5 to be flowed in the resistor R, thereby preventing a high-level voltage from being charged in a second capacitor C2.

Further, as shown in FIG. 4, the surge snubber 130 may include an switching element, that is, a fifth diode D5 having one end connected in parallel between the first inductor L1 and the first switching element 141, a third capacitor C3 connected in series between the other end of the fifth diode D5 and a ground, and a DC converter 135 connected between the other end of the fifth diode D5 and the ground.

The surge snubber 130 of FIG. 4 may cause an eliminated current If corresponding to a portion of a surge current Id applied through the fifth diode D5 to be applied to the DC converter 135. As a result, it is possible to prevent the second capacitor C2 from being charged with a high-level voltage.

At this time, the DC converter 135 may generate two correction voltages, e.g., a first to voltage (VH) and a second voltage (VL), from the eliminated current If. The generated first voltage VH and the generated second voltage VL may be applied to a node H and a node L respectively on both ends of the first capacitor C1 of the power factor correction converter 140. Accordingly, the voltage charged in the first capacitor C1 may be as large as the correction voltage generated in the DC converter 135. In other words, the surge snubber 130 can convert a portion of the surge current Id into a voltage to be provided as the correction voltage to the first capacitor C1, thereby charging the high voltage battery HVB quickly and steadily.

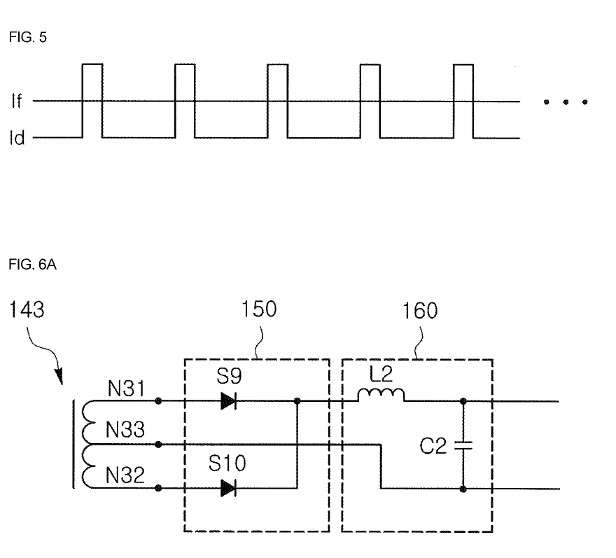

FIG. 5 is a diagram showing an operation of the surge absorber of FIG. 2.

As shown in FIG. 5, the eliminated current If having a size corresponding to an average value of the surge current Id may be applied to the surge snubber 130. Further, the eliminated current If may be provided as a correction voltage to an output terminal of the power factor correction converter 140 by consuming and eliminating the eliminated current If through the resistor R as in the surge snubber 130 of FIG. 3 or generating the voltages from the eliminated current If through the DC converter 135 as in the surge snubber 130 of FIG. 4. Here, the surge current Id may be a current having a duty ratio of 0.1 to 0.2.

Referring again to FIGS. 2 to 4, the LDC circuit 100B may include the transformer 143 and the second switching unit 145 of the power factor correction converter 140, the tertiary-side rectifier 150, and an LC fitter 160. The LDC circuit 100B may convert the high-voltage direct current power source supplied from the high voltage battery HVB into a low voltage direct current power source and provide the converted direct current power source to a low voltage battery LVB, thereby charging the low voltage battery LVB. Here, since the transformer 143 and the second switching unit 145 in the LDC circuit 100B are the same as the transformer 143 and the second switching unit 145 configured in the OBC circuit 100A described above, the description thereof will be omitted.

The tertiary-side rectifier 150 may be connected to the tertiary-side terminals N31 and N32 of the transformer 143. The tertiary-side rectifier 150 may convert the high voltage power source applied through the second switching unit 145, and secondary-side terminals N21 and N22 and the tertiary-side terminals N31 and N32 of the transformer 143, into a low-voltage direct current power source, thereby outputting the low-voltage direct current power source.

The tertiary-side rectifier 150 may include a ninth switching element S9 and a tenth switching element S10. One end of the ninth switching element S9 may be connected to one tertiary-side terminal N31 of the transformer 143. One end of the tenth switching element 810 may be connected to the other tertiary-side terminal N32 of the transformer 143. The other end of each of the ninth switching element S9 and the tenth switching element S10 may be connected in common to one end of the second capacitor C2 of the LC filter 160.

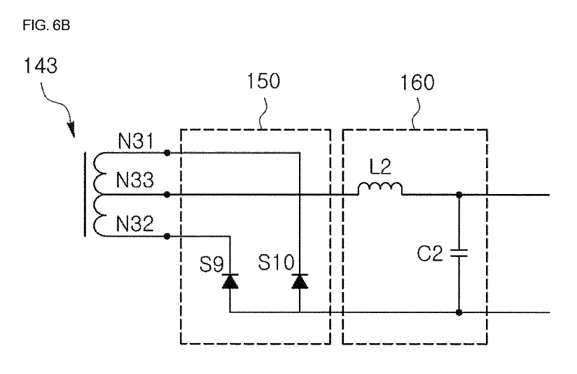

The ninth switching element S9 and the tenth switching element 810 of the tertiary-side rectifier 150 described above may be configured with FETs and may be configured with diodes as shown in FIGS. 6A and 6B.

Referring to FIG. 6A, the ninth switching element S9 and the tenth switching element 810 of the tertiary-side rectifier 150 may be configured with diodes.

An anode electrode of each of the ninth switching element S9 and the tenth switching element S10 may be connected to the tertiary-side terminals N31 and N32 of the transformer 143, respectively. A cathode electrode of each of the ninth switching element S9 and the tenth switching element S10 may be connected in common to one end of a second inductor L2 of the LC filter 160.

Referring to FIG. 6B, the ninth switching element S9 and the tenth switching element S10 of the tertiary-side rectifier 150 may be configured with diodes.

A cathode electrode of each of the ninth switching element S9 and the tenth switching element S10 may be connected to the tertiary-side terminals N31 and N32 of the transformer 143, respectively. An anode electrode of each of the ninth switching element S9 and the tenth switching element S10 may be connected in common to one end of the second capacitor C2 of the LC filter 160.

Referring to FIGS. 2 to 4 again, the LC filter 160 may be connected between the tertiary-side rectifier 150 and the low voltage battery LVB. The LC filter 160 may smooth the low-voltage direct current power source provided from the tertiary-side rectifier 150. The LC filter 160 may include the second inductor L2 connected to the intermediate terminal N33 of the transformer 143 and the second capacitor C2 connected in parallel thereto.

As described above, the complex circuit for charging and low-voltage conversion for an electric vehicle according to the present embodiment includes the OBC circuit 100A for generating the high-voltage direct current power source to charge the high voltage battery HVB and the LDC circuit 100B for generating the low-voltage direct current power source to charge the low voltage battery LVB, in which a partial configuration of the power factor correction converter 140 of the OBC circuit 100A, that is, the transformer 143 and the second switching unit 145 may be shared in the LDC circuit 100B. Accordingly, the present invention makes it possible to reduce the number of elements and a size of the entire circuit in the complex circuit for charging and low-voltage conversion, thereby reducing manufacturing cost.

In addition, with the complex circuit of the present invention, since a voltage conversion circuit is not required to be provided at the output terminal of the LDC circuit 100B, it is possible to reduce loss during voltage conversion.

In addition, the complex circuit of the present invention can improve an operation reliability of the OBC circuit 100A by removing the surge current generated due to an inductance collision or converting the surge current into the voltage to provide the voltage to the output terminal of the OBC circuit 100A.

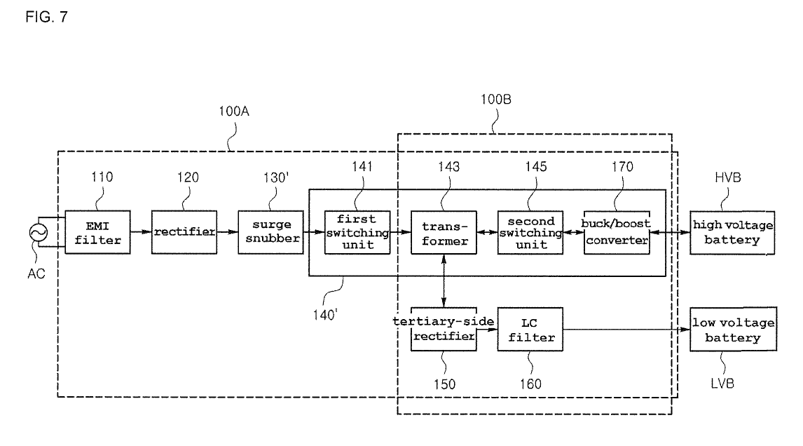

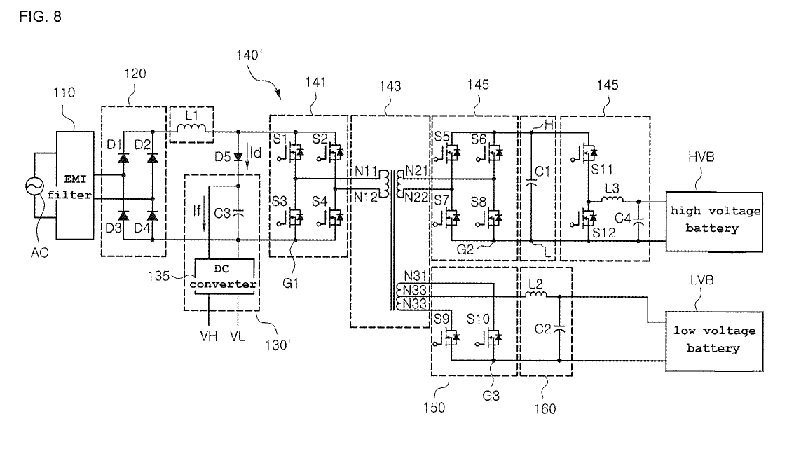

FIG. 7 is a diagram illustrating a configuration of a complex circuit for charging and low-voltage conversion for an electric vehicle according to another embodiment of the present invention; and FIG. 8 is a circuit diagram of FIG. 7.

The complex circuit for charging and low-voltage conversion for an electric vehicle shown in FIGS. 7 and 8 has substantially the same configuration to the circuit described with reference to FIGS. 2 to 4, except that a buck/boost converter 170 is included in a power factor correction converter 140′. Therefore, the same reference numerals are used for the same elements, and a detailed description thereof will be omitted. Referring to FIGS. 7 and 8, the complex circuit for charging and low-voltage conversion for the electric vehicle according to the present embodiment may include the OBC circuit 100A for charging the high voltage battery HVB of the electric vehicle and the LDC circuit 100B for charging the low voltage battery LVB of the electric vehicle.

The OBC circuit 100A may include the EMI filter 110, the rectifier 120, the surge snubber 130, and the power factor correction converter 140′. The power factor correction converter 140′ may include the first inductor L1, the first switching unit 141, the transformer 143, the second switching unit 145, the first capacitor C1, and the buck/boost converter 170. The LDC circuit 100B includes a part of the power factor correction converter 140′ of the OBC circuit 100A, i.e., the transformer 143, the second switching unit 145, and the buck/boost converter 170, the tertiary-side rectifier 150, and the LC filter 160.

The OBC circuit 100A and the LDC circuit 100B described above may be operated to allow the high voltage battery HVB or the low voltage battery LVB to be charged in accordance with the switching operation of the first switching unit 141 and the second switching unit 143 of the power factor correction converter 140′.

Here, the power factor correction converter 140′ may have an insulating-type structure. In addition, the surge snubber 130 may consume and eliminate a portion of the surge current generated due to the inductance collision in the power factor correction converter 140′, or may convert a portion of the surge current into a voltage to provide the voltage to the output terminal of the OBC circuit 100A as the correction voltage.

The buck/boost converter 170 may be a bidirectional converter circuit. For example, when the complex circuit for charging and low-voltage conversion is operated as the OBC circuit 100A for charging an electric vehicle, the buck/boost converter 170 is operated as a buck converter so that the externally applied alternating current power source AC may be converted to high-voltage direct current power source to be charged in the high voltage battery HVB. In addition, when the complex circuit for charging and low-voltage conversion is operated as the LDC circuit 100B for the electric vehicle part of the electric vehicle, the buck/boost converter 170 is operated as a boost converter so that the high-voltage direct current power source applied from the high voltage battery HVB is converted into the low-voltage direct current power source to be charged in the low voltage battery LVB.

The buck/boost converter 170 described above may include an eleventh switching element S11 composed of a FET or a diode, a twelfth switching element S12, a third inductor L3, a fourth capacitor C4. The eleventh switching element S11 and the twelfth switching element S12 are connected in parallel with the first capacitor C1. The third inductor L3 and the fourth capacitor C4 are connected between the eleventh switching element S11 and the twelfth switching element S12 to constitute the LC filter.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A complex circuit for charging and low-voltage conversion for an electric vehicle, the complex circuit comprising:
a rectifier for rectifying an alternating current power source applied from an outside;
a power factor correction converter including a first inductor, a transformer, a first switching unit connected to primary-side terminals of the transformer, a second switching unit connected to secondary-side terminals of the transformer, and a first capacitor, the power factor correction converter having an insulating-type structure by the transformer;
a surge snubber configured to eliminate a surge current due to an inductance collision of the first inductor and the transformer;
a tertiary-side rectifier connected to tertiary-side terminals of the transformer; and
an LC filter for smoothing an output of the tertiary-side rectifier,
wherein the power factor correction converter allows a high-voltage power source generated from the alternating current power source to be provided to a high voltage battery, or allows the high voltage power source provided from the high voltage battery to be provided to the tertiary-side rectifier and the high voltage power source to be converted into a low voltage power source by the tertiary-side rectifier to be provided to a low voltage battery.

2. The complex circuit of claim 1, wherein the surge snubber includes:
a switching element having a first end connected in parallel between the first inductor and the first switching unit;
a third capacitor connected in series between a second end of the switching element and a ground; and
a resistor connected in parallel with the third capacitor between the second end of the switching element and the ground,
wherein an eliminated current corresponding to a portion of the surge current applied through the switching element is consumed and thus eliminated by the resistor.

3. The complex circuit of claim 2, wherein a size of the eliminated current is an average value of the surge current.

4. The complex circuit of claim 1, wherein the surge snubber includes:
a switching element having a first end connected in parallel between the first inductor and the first switching unit;
a third capacitor connected in series between a second end of the switching element and a ground; and
a DC converter connected in parallel with the third capacitor between the second end of the switching element and the ground,
wherein an eliminated current corresponding to a portion of the surge current applied through the switching element is converted into a voltage by the DC converter and the voltage is provided as a correction voltage to an output terminal of the power factor correction converter.

5. The complex circuit of claim 4, wherein a size of the eliminated current is an average value of the surge current.

6. The complex circuit of claim 1, wherein the power factor correction converter allows the high voltage power source to be generated from the alternating current power source in accordance with switching operations of both the first switching unit and the second switching unit in a charging mode, and allows the high voltage power source to be provided to the tertiary-side rectifier in accordance with a switching operation of only the second switching unit in a low-voltage conversion mode.

7. The complex circuit of claim 1, wherein the first inductor is connected between the rectifier and the first switching unit, and the first capacitor is connected in parallel between the second switching unit and the high voltage battery.

8. The complex circuit of claim 1, further comprising a buck/boost converter connected between the first capacitor and the high voltage battery for charging the high voltage battery with the high voltage power source or converting the high voltage power source into the low voltage power source.

9. The complex circuit of claim 1, wherein the tertiary-side rectifier includes a pair of FETs having respective first ends respectively connected to the tertiary-side terminals of the transformer and respective second ends connected in common to a capacitor of the LC filter.

10. The complex circuit of claim 1, wherein the tertiary-side rectifier includes a pair of diodes having respective anode electrodes respectively connected to the tertiary-side terminals of the transformer and respective cathode electrodes connected in common to an inductor of the LC filter.

11. The complex circuit of claim 1, wherein the tertiary-side rectifier includes a pair of diodes having respective anode electrodes connected in common to a capacitor of the LC filter and respective cathode electrodes respectively connected to the tertiary-side terminals of the transformer.
